(19) United States
(12) Patent Application Publication
(10) Pub. No.: US 2006/0212658 A1
(43) Pub. Date: Sep. 21, 2006

(54) Prefetch performance of index access by look-ahead prefetch

(75) Inventors: Namik Hrle, Boeblingen (DE); You-Chin Fuh, San Jose, CA (US); Yoichi Tsuji, San Jose, CA (US); Li Xia, San Jose, CA (US)

Correspondence Address: Min, Hsieh & Hack, LLP;c/o PortfolioIP, P.O. Box 52050, Minneapolis, MN, 55402, US

(73) Assignee: INTERNATIONAL BUSINESS MACHINES CORPORATION.

(21) Appl. No.: 11/083,289

(22) Filed: Mar. 18, 2005

(51) Int. Cl. G06F 12/00

(52) U.S. Cl. 711/137

(57) ABSTRACT

Embodiments of the present invention provide a “look-ahead” form prefetch. Look-ahead prefetch may utilize a look-ahead queue to prefetch multiple pages asynchronously. The look-ahead queue may hold a plurality of search keys that are related to a transaction. When accessing a table, an index manager may retrieve the table's index and scan the index based on the search keys from the look-ahead queue to find the RIDs in the table that match the search keys. The index manager may then accumulate these RIDs into a prefetch list. A prefetch manager may read the prefetch list, determine locations for the pages of the table that contain the records identified by the RIDs, and dispatch prefetch tasks to the appropriate storage device for these pages.

### FIELD

The present invention relates to database transactions. In particular, the present invention relates to prefetching records before they are requested by a transaction.

### BACKGROUND

Physically, databases are typically stored in a storage device, such as a magnetic disk or optical disk. However, the input/output (I/O) operations involving storage media are much slower than the I/O operations from memory. Therefore, most database management systems use a combination of storage devices and memory.

An important performance objective in database systems is to minimize the number and effect of storage I/O operations. Prefetching is a process where data is retrieved from a storage device into memory before they are requested by a transaction of the database management system. Therefore, prefetching can reduce I/O time significantly by making data pages available in memory before they are requested or needed.

Currently, there are three major types of prefetch: sequential prefetch; dynamic prefetch; and list prefetch. Sequential prefetch is where a transaction for a page triggers the prefetch of a set of consecutive pages that follows the triggering page. The triggering page is a page with a page number that is a multiple of a predetermined prefetch quantity. Sequential prefetch for a query is determined at its bind time. Sequential prefetch is generally used when more than a predefined threshold number of pages of data are accessed.

Unfortunately, sequential prefetch is limited in its applicability. Because sequential prefetch retrieves consecutive pages from storage, it is only effective with data that has a high cluster ratio. In addition, sequential prefetch is prone to optimization errors, because it can be difficult to calculate the optimal number of consecutive pages to fetch from storage.

Dynamic prefetch also fetches a set of consecutive pages in parallel. However, unlike sequential prefetch, dynamic prefetch is determined at execution time rather than at bind time. Dynamic prefetch is typically triggered whenever a sequential access pattern is detected.

Because it is invoked at execution time, dynamic prefetch can avoid some of the weakness of sequential prefetch by triggering prefetches dynamically at execution time of a database transaction. Dynamic prefetch performs well in the scenarios where sequential prefetch performs well. However, dynamic prefetch also has several drawbacks. For example, dynamic prefetch does not apply when the sequential access pattern detection fails. In addition, dynamic prefetch does not perform well with low clustered indexes.

In contrast to sequential or dynamic prefetch, list prefetch fetches a set of non-consecutive pages. In list prefetch, a table index is probed and a list record or row identifiers (RIDs) is accumulated. This list of RIDs is sorted into a sequential order and pages of data that correspond to the RIDs are fetched.

However, list prefetch also has several limitations. Depending on how many RIDs are accumulated, the memory space that holds the list of RIDs is prone to overflow. List prefetch requires more processing time in order to sort the RIDs. After the RIDs are sorted, the ordering of the index is lost. In addition, list prefetch is a sequential process, and thus, can not be performed asynchronously or in a pipelined manner.

Therefore, it may be desirable to provide a prefetch mechanism avoids the limitations of known prefetch schemes.

### SUMMARY

In accordance with one feature of the invention, a method of prefetching records of a table before they are requested by a transaction is provided. The transaction is based on a set of keys and a plurality of the set of keys of the transaction are queued. An index of the table is scanned based on the queued set of keys. Locations of records in the table are accumulated based on the scan of the index. Respective pages that include the accumulated records are determined. The pages that include the accumulated records are then fetched before they are requested by the transaction.

In accordance with another feature of the invention, a system that processes transactions is provided. The system is configured to prefetch records of a table before they are requested by the transactions and comprises: at least one look-ahead queue having entries for search keys specified in a transaction; a buffer pool that comprises at least a portion of a table and an index of the table, wherein the index comprises a set of entries each having an index key that indicates a value for a field of the table and a record identifier that indicates a location of a record that has the value in the field; an index manager that is configured to scan the index based on the search keys in the entries in the look-ahead queue and write the record identifiers of the records in the table that satisfy the search keys into a prefetch list; and a prefetcher that is configured to read the prefetch list, determine a set of pages that contain the records that satisfy the search keys, and fetch the set of pages before they are requested by the transaction.

Additional features of the invention will be set forth in part in the description which follows, and in part will be obvious from the description, or may be learned by practice of the invention. It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 shows an exemplary system that is consistent with embodiments of the present invention;

FIG. 2 shows an exemplary server that is consistent with embodiments of the present invention;

FIG. 3 shows a functional architecture of a database services component that is consistent with embodiments of the present invention; and

FIG. 4 illustrates an exemplary architecture of the processes and components of an exemplary server that is consistent with embodiments of the present invention.

### DESCRIPTION OF THE EMBODIMENTS

Embodiments of the present invention provide a “look-ahead” form prefetch. Look-ahead prefetch may utilize a look-ahead queue to prefetch multiple pages asynchronously. The look-ahead queue may hold a plurality of search keys that are related to a transaction. When accessing a table, an index manager may retrieve the table's index and scan the index based on the search keys from the look-ahead queue to find the RIDs in the table that match the search keys. The index manager may then accumulate these RIDs into a prefetch list. A prefetch manager may read the prefetch list, determine locations for the pages of the table that contain the records identified by the RIDs, and dispatch prefetch tasks to the appropriate storage device for these pages.

Reference will now be made in detail to exemplary embodiments of the invention, which are illustrated in the accompanying drawings. Wherever possible, the same reference numbers will be used throughout the drawings to refer to the same or like parts.

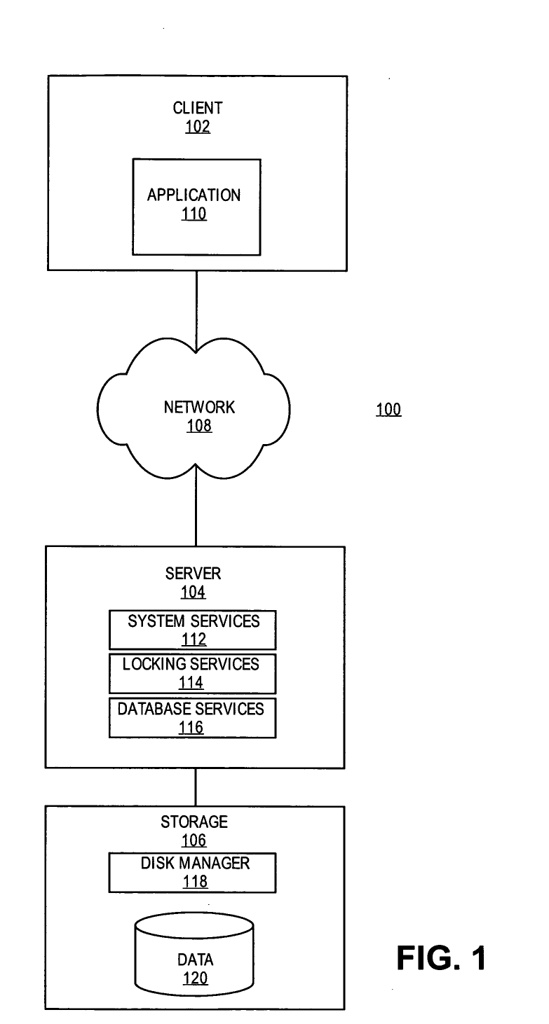

FIG. 1 shows an exemplary system 100 that is consistent with embodiments of the present invention. As shown, system 100 may include a client 102, a server 104, and storage 106. These components may be coupled together using one or more networks, such as network 108. Network 108 may be implemented as any form of communications infrastructure, such as a local area network, or wide area network. In addition, these components may communicate with each other using known protocols and will now be further described.

Client 102 provides a user interface to system 100. Client 102 may be implemented using a variety of devices and software. Client 102 may be implemented on a personal computer, workstation, or terminal. In addition, client 102 may run applications, such as application 110, under an operating system, such as the Windows® operating system by Microsoft® Corporation, or through a browser application, such as Internet Explorer™ by Microsoft® Corporation or Netscape Navigator™ by Netscape Communications® Corporation. Although FIG. 1 shows a single client, system 100 may include any number of clients.

As shown, client 102 may include an application 110 that is invoked by a user to access a database that is managed by server 104. Application 110 may include a user interface provided by International Business Machines, or other similar interface, to communicate with server 104. For example, a user may use application 110 to perform various search and retrieval functions, or termed queries against a database managed by server 104. In some embodiments, these queries may conform to the Structured Query Language (SQL) standard, and invoke functions performed by a Relational Database Management System (RDBMS). Those skilled in the art will recognize, however, that embodiments of the present invention may include a variety of application programs that interface a database, whether or not the queries use SQL.

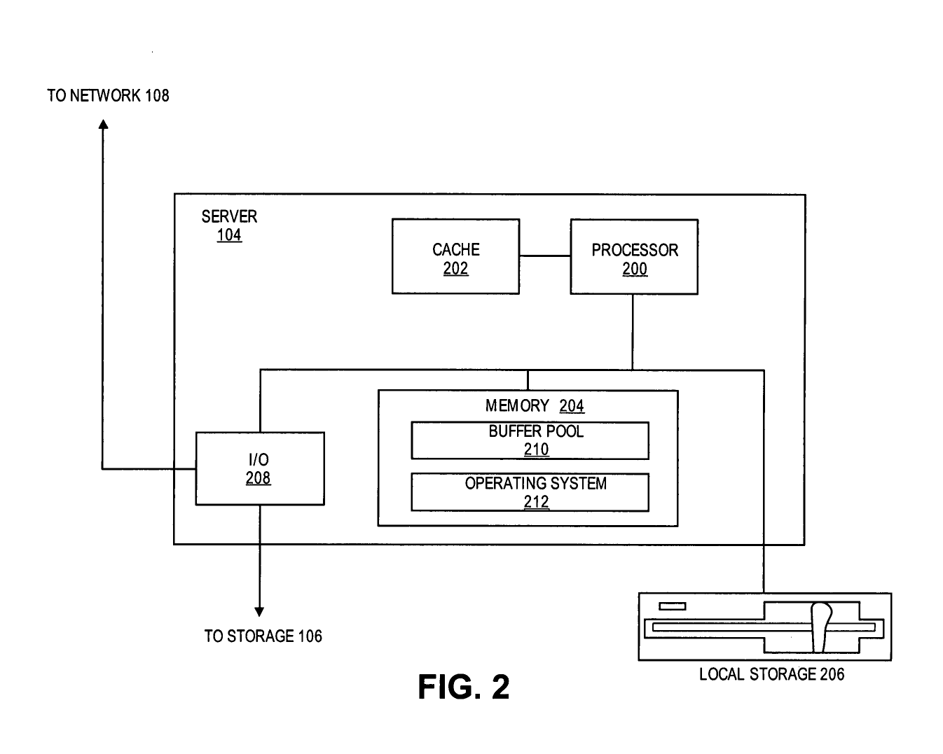

Server 104 provides a platform for the RDBMS. Server 104 may be implemented on a variety of devices and software. For example, server 104 may be a computer that runs one or more application programs and stored procedures under an operating system, such as z/OS®, Windows®, AIX®, or Solaris®. An exemplary architecture for the structure of server 104 is described with reference to FIG. 2.

In some embodiments, server 104 may use the DB2® Universal Database™ by International Business Machines Corporation (IBM®). For example, as shown, server 104 may comprise three major functional components, a system services component 112, a locking services component 114, and a database services component 116.

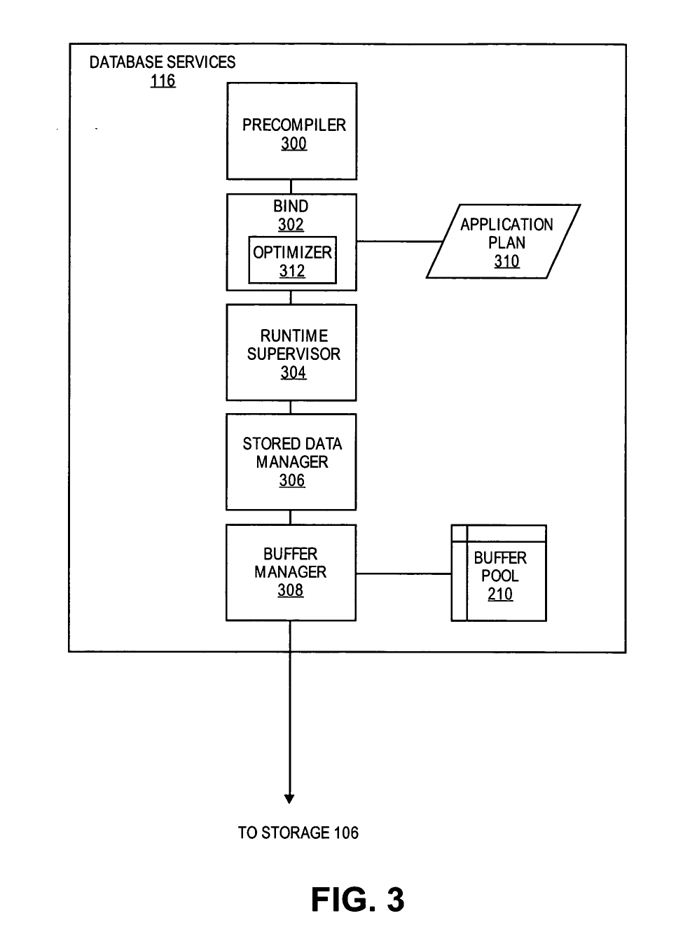

System services 112 controls the overall execution environment of server 104 including: managing log data sets; gathering statistics; handling startup and shutdown; providing management support; communications with client 102; and similar functions. Locking services 114 provides controls for managing concurrent access to the data of the RDBMS. For example, locking services 114 may provide services that allow any number of users to access the same data simultaneously, isolate users and to maintain data integrity. Database services 116 support the definition, retrieval, and update of user and system data. In some embodiments, database services 116 provide prefetch mechanisms, such as a look-ahead prefetch. Database services 116 are further described with reference to FIG. 3.

Storage 106 comprises the components that are responsible for the storage of data in system 100. Storage 106 may be implemented with known components of hardware and software. For example, storage 106 may include one or more storage devices or containers, such as direct access storage devices (DASD), magnetic disk drives, or optical disk drives. As shown, in some embodiments, storage 106 may include a disk manager 118 that manages data 120.

Disk manager 118 manages the physical I/O operations for storage 106. For example, in some embodiments, disk manager 118 may manage data 120 based on data pages. That is, disk manager 118 may regard the physical disk space that embodies data 120 as a logical collection of page sets, each one comprising a collection of fixed-sized pages. Each page set may be identified by a unique page set ID and each page in turn may be identified by a page number that is unique to a particular drive of storage 106. In some embodiments, each page may contain approximately 4 Kbytes. Disk manager 118 may thus maintain a mapping between page numbers and physical addresses in data 120. In turn, a table of the RDBMS may include one or more these pages that are stored and managed by disk manager 118.

In addition, storage 106 may support various forms of clustering. For example, storage 106 may support both intra-file and inter-file clustering. In addition, storage 106 may support different types of clustering for different types of files. Other implementations of clustering are well known to those skilled in the art.

FIG. 2 shows a server 104 that is consistent with embodiments of the present invention. As shown, server 104 may include a central processor 200, a cache 202, a main memory 204, a local storage device 206, and an input/output controller 208. These components may be implemented based on hardware and software that is well known to those skilled in the art.

Processor 200 may include cache 202 for storing frequently accessed information. Cache 202 may be an “on-chip” cache or external cache. Server 104 may also be provided with additional peripheral devices, such as a keyboard, mouse, or printer (not shown). In the embodiment shown, the various components of server 104 communicate through a system bus or similar architecture.

Although FIG. 2 illustrates one example of the structure of server 104, the principles of the present invention are applicable to other types of processors and systems. That is, the present invention may be applied to any type of processor or system that serves as a database platform. For example, server 104 may comprise multiple processors, such as those provided by the Intel Corporation, or may comprise multiple computers that are linked together.

In addition, memory 204 may comprise a buffer pool 210 and an operating system 212. Buffer pool 210 is an area of memory 204 that is allocated for operations of the RDBMS, such as caching data pages of a table as new data is added or as data is retrieved for a table from storage 106. Buffer pool 210 may be created as part of the database creation process. In some embodiments, buffer pool 210 may be allocated approximately 250 to 1,000 pages of 4 KB of memory 204. Of course, one skilled in the art will recognize that buffer pool 210 may be allocated any number or type of pages. In addition, memory 204 may include any number of buffer pools. For example, the number of buffer pools allocated in memory 204 may depend on the amount of memory available to server 104.

Operating system (OS) 212 is an integrated collection of routines that service the sequencing and processing of programs and applications by server 104. OS 212 may provide many services for server 104, such as resource allocation, scheduling, input/output control, and data management. OS 212 may be predominantly software, but may also comprise partial or complete hardware implementations and firmware. Well-known examples of operating systems that are consistent with the principles of the present invention include the z/OS operating system, LINUX, and UNIX.

FIG. 3 shows a functional architecture of database services component 116 that is consistent with embodiments of the present invention. As shown, database services 116 may comprise a precompiler 300, a bind component 302, a runtime supervisor 304, a stored data manager 306, and a buffer manager 308. In some embodiments, these components are implemented based on the hardware and software illustrated in FIG. 2. For example, the components of database services 114 may be implemented as threads or processes that are being executed by processor 200 of server 104 in conjunction with cache 202, OS 212, and buffer pool 210. The functions and structure of the components of database services 116 will now be described.

Precompiler 300 processes queries from application 110 of client 102 and formats various calls to runtime supervisor 304. For example, queries from application 110 may be written in SQL. Precompiler 300 may then translate the SQL into a database request module (DBRM) that contains host programming language calls to runtime supervisor 304. In some embodiments, precompiler 300 may produce DBRMs that are consistent with DB2 databases.

Bind component 302 compiles one or more related DBRMs from precompiler 302 to produce an application plan 310. Application plan 310 comprises code that is executable by processor 200 to implement the SQL statements in the DBRMs. Application plan 310 may include one or more subplans that specify the access path for data requested by a transaction. For example, the subplan may specify an access path that utilizes a table's index. Index access for a table may be specified because indexes are generally smaller in size than the tables they represent, may be stored and easily accessed from buffer pool 210. The index will generally provide a mapping of the records in a table and locations of the corresponding pages in storage 106. Therefore, in some embodiments, the index may be used to anticipate when records will be requested by a transaction.

As shown, bind component 302 may include an optimizer 312 that assists in producing application plan 310. In particular, optimizer 312 may choose, for each SQL manipulative statement, an access plan for implementing that statement. For example, optimizer 312 may determine the transactions involved in implementing a statement, and choose various strategies for accessing records requested by these transactions, such as an index access plan. In some embodiments, optimizer 312 may consider which tables are referenced by a transaction for a statement, how large these tables are, what indexes exist for these tables, how the data is physically clustered within storage 106, and the form of the clauses in the statement.

Some of the strategies that optimizer 312 can select may include various prefetch mechanisms. In some embodiments, optimizer 312 may include sequential prefetch, dynamic prefetch, list prefetch, and look-ahead prefetch as part of application plan 310. For example, optimizer 312 may use sequential prefetch and dynamic prefetch for data that is highly clustered in storage 106. As another example, optimizer 312 may use look-ahead prefetch for transactions that involve a pipelined access plan with index access to a table, such as an inner table of a SQL JOIN operation. In particular, when optimizer 312 detects a pipelined index-access subplan in application plan 310 on an inner table, a look-ahead prefetch may be specified at bind time. Accordingly, at execution time, when index probing on the inner table commences, instead of probing the index with one searching key value, the index may be probed with several search keys.

Look-ahead prefetch may improve index scan performance dramatically where dynamic prefetch or list prefetch are not applicable, especially when the index cluster ratio is low. In some embodiments, look-ahead prefetch does not require sequential or nearly sequential data access pattern on a table. In addition, look-ahead prefetch may be useful for tables that have indexes with a low cluster ratio. Furthermore, look-ahead prefetch may retrieve non-consecutive pages. In other embodiments, look-ahead prefetch may not require sorting of RIDs, suffer from RID pool limitations, and may preserve index ordering.

Runtime supervisor 304 supervises the execution of SQL programs by processor 200. When a program requires a database operation or transaction, control of server 104 passes to runtime supervisor 304 based on the calls inserted by precompiler 300. Runtime supervisor 304 may then execute application plan 310 and pass control to stored data manager 306 as specified by application plan 310.

Stored data manager 306 manages the stored database, such as data 120. Stored data manager 306 may control the retrieving and updating of records in data 120 based on the transactions specified in application plan 310. Stored data manager 306 may also invoke other components, such as system services 112 and locking services 114, to perform the transactions requested by application plan. In order to perform IO tasks for the retrieval and update of records, stored data manager 306 may invoke buffer manager 308.

Buffer manager 308 may operate in conjunction with disk manager 118 and be responsible for physically transferring data from storage 106 to memory 204 and into buffer pool 210. In addition, buffer manager 308 may be responsible for retrieving stored records from storage 106, or buffer pool 210, replacing stored records in either storage 106 or buffer pool 210, or adding or removing records in storage 106 or buffer pool 210.

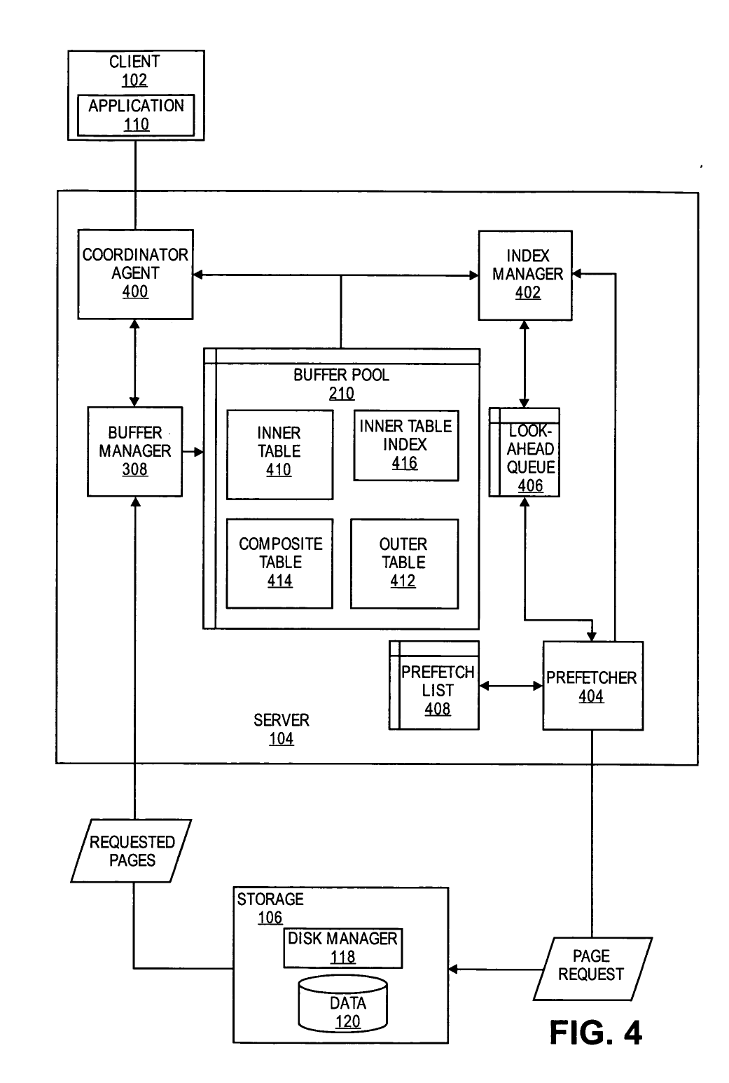

In some embodiments, buffer manager 308 may place a page (or pages) for a table that contain requested data into buffer pool 210 before passing the data itself onto application 110. Each time a new query is processed, buffer manager 308 may search buffer pool 210 to see if the page that is requested by a transaction already resides in memory 204. If so, it's immediately passed on to the appropriate application, such as application 110. However, if the data requested cannot be found in buffer pool 210, buffer manager 308 may retrieve it from storage 106 and copy it to buffer pool 210 before passing it on. Various pages may also be prefetched and copied into buffer 210 before they are requested by a transaction. As noted, one of the prefetch mechanisms that may be used by server 104 is a look-ahead prefetch. Some aspects of the look-ahead prefetch mechanisms will now be described with reference to FIG. 4.

FIG. 4 illustrates an exemplary architecture of the processes and components of server 104 that is consistent with embodiments of the present invention. In particular, the activity of server 104 may be controlled by a coordinator agent 400, an index manager 402, and a prefetcher 404. For purposes of explaining various aspects of look-ahead prefetches, FIG. 4 also shows other components that have been previously described, such as client 102, storage 106, buffer manager 308, and buffer pool 210.

Coordinator agent 400 coordinates the processing for application 110 and communicates with application 110 on behalf of runtime supervisor 304 and stored data manager 306 (not shown in FIG. 4). Coordinator agent 400 may be implemented as threads (e.g., when OS 212 is a Windows operating system) or as processes (e.g., when OS 212 is a UNIX operating system) that are being executed by processor 200. Coordinator agent 400 may work together with other agents or sub-agents to process the transactions related to query.

Index manager 402 access indexes of tables and scans these indexes based on the search keys of a transaction. Prefetcher 404 brings pages from storage 106 into buffer pool 210 before they are requested by a transaction. For example, prefetcher 404 may send asynchronous read-ahead requests to a common prefetch list, such as prefetch list 408. Prefetcher 404 may implement big-block or scatter read input operations to bring pages from storage 106 to buffer pool 210. Prefetcher 404 may also send read operations to multiple disks of storage 106 at the same time to retrieve pages of data before they are requested by a transaction. Index manager 402 and prefetcher 404 may be implemented as a thread or process that is being executed by processor 200.

Look-ahead queue 406 is designed to provide “look-ahead” information to index manager 402. A look-ahead queue may be assigned to each index access for a table where optimizer 312 has identified a look-ahead prefetch as being applicable. For example, in some embodiments, for each table with index scan in a pipelined subplan of application plan 310, one look-ahead queue may be assigned

Look-ahead queue 406 may contain several search keys from composite tables of a query. In addition, look-ahead queue 406 may be allocated with various numbers of entries to suit different conditions. For example, the number of entries in look-ahead queue 406 may depend on the workload and resource availability of buffer pool 210. For some tables, a large number of RIDs may match a relatively small number of search keys. Hence, in some embodiments, look-ahead queue 406 may comprise a relatively small number of entries. Accordingly, if buffer pool 210 is busy, then look-ahead queue 406 may be configured with a smaller number of entries. The number of entries may be based on avoiding prefetched pages from being cleaned out of buffer pool 210 before being requested by a transaction. Conversely, if buffer pool 210 is idle, then look-ahead queue 406 may be configured with a larger number of entries to fully utilize the capacity of buffer pool 210. As another example, if a small number of RIDs match search keys in entries of look-ahead queue 406, a larger number of entries in look-ahead queue 406 may be preferred.

The entries in look-ahead queue 406 may be sequenced by the order in which the search keys are to be processed by index manager 402. The search key in the top entry of the queue may be considered the “current” search key value being processed. In some embodiments, index manager 402 will iteratively pull entries from look-ahead queue 406 until all the entries have been processed and the invoker, such as stored data manager 306, of index manager 402 may fill (or retrieve) the matching index leaf page addresses in prefetch list 408 for all the entries in look-ahead queue 406. Accordingly, in these embodiments, a look-ahead prefetch will always prefetch a page before that page is requested by a transaction. When look-ahead queue 406 is empty, the invoker, such as stored data manager 306 or a SQL query, of index manager 402 may then fill it with several searching key values for the next index and scan. In some embodiments, look-ahead queue 406 is not refilled until it is emptied of search key entries.

In addition, index manager 402 may generate a prefetch list 408 that indicates all the RIDs that match the searching keys included in look-ahead queue 406. Prefetch list 408 may be preallocated in memory 204 with a maximum size, or may be dynamically allocated by index manager 402 with a calculated size. In some embodiments, one prefetch list is maintained for each look-ahead queue. Index manager 402 may also return the matching RIDs to coordinator agent 400 for passage to application 110 for the current search key.

Prefetcher 404 processes the prefetch list 408 and schedules I/O operations to retrieve all the RIDs for a transaction in prefetch list 408. In some embodiments, prefetcher 404 may perform this processing in parallel or asynchronously in relation to the processing by index manager 402 of the search keys in look-ahead queue 406. After prefetching of all the RIDs in prefetch list 408 have been scheduled, prefetcher 404 may then clear prefetch list 408. For example, prefetcher 404 may set a flag, such as “rid_empty flag” to indicate to index manager that prefetch list 408 is empty and can accept new entries.

Prefetch list 408 may be preallocated in memory 204 with a maximum size. In some embodiments, in order to avoid an overflow of prefetch list 408, index manager 408 may maintain a continuation indicator, such as a flag “rid_fill_cont”, that is set to on/off by the invoker of index manager 402 to indicate that prefetch list 408 needs to continue to be filled. In this circumstance, index manager will also remember its current processing state using a flag, such as “next_prefetch_entry.” Now that examples of the various components have been described, some of the actions performed for a look-ahead prefetch will now be described again with reference to FIG. 4.

To aid in the explanation, FIG. 4 shows an inner table 410, an outer table 412, and a composite table 414. These tables may include one or more pages that are stored in buffer pool 210. In addition, these tables may also include one or more pages that are stored in data 120 of storage 106. In addition, inner table 410 is indexed by index table 416. Index table 416 provides a compressed or reduced representation of the inner table 410 and the locations of its constituent data pages in storage 106. In some embodiments, index table 416 is small enough to be stored within buffer pool 210.

The operations for prefetching of pages for inner table 410 from storage 106 into buffer pool 210 will now be described. In the embodiments described below, the operations for a look-ahead prefetch are performed asynchronously. That is, index manager 402 may perform some of its operations asynchronously relative to the operations by prefetcher 404, as well as the other components shown in FIG. 4.

For convenience, the operations of prefetcher 404 will now be described. Periodically, prefetcher 404 may check prefetch list 408. The periodicity may be configured by a system administrator, by processor 200, or by application plan 310, etc. If prefetch list 408 contains entries, then prefetcher 404 will schedule prefetches from storage 106 for the RIDs of table indicated in prefetch list 408 until all the RIDs have been scheduled. Prefetcher 404 may detect when prefetch list 408 is non-empty or full based on a flag, such as a “rid_empty.” When prefetcher 404 has scheduled all the RIDs in prefetch list 408, then prefetcher 404 may set the rid_empty flag accordingly.

Meanwhile, the invoker of index manager 402 may check whether look-ahead queue 406 is empty or needs to be filled. In some embodiments, the invoker of index manager 402 may detect whether look-ahead queue 406 is empty or needs filling based on a flag, such as a “queue_refill” flag. If look-ahead queue 406 is empty, then the invoker of index manager 402 may fill in a plurality of entries into look-ahead queue 406 and set the queue-refill flag to value, such as “yes.” Each entry of look-ahead queue 406 may include data that represents one or more search keys that index manager 402 will use to scan index table 416. If look-ahead queue 406 is not empty, then the invoker of index manager 402 may reset the queue_refill flag accordingly, such as to a value of “no.”

As index manager 402 scans index table 416, it will iteratively use the top entry of look-ahead queue 406 as the search key of its current scan. Alternatively, if index manager 402 finds that a matching index leaf page address in index table 416 is zero, index manager 402 will “pop” the top entry out of look-ahead queue 406, and thus, cause processing to proceed to the next search key held in look-ahead queue 406. In other embodiments, when index manager 402 has finished returning all the matching data page addresses for the current search key in look-ahead queue 406, index manager 402 may pop the top entry out of look-ahead queue 406 and proceed to processing of the next search key.

When look-ahead queue 406 has just been refilled, index manager 402 will perform several operations. Index manager 402 will find corresponding index leaf pages in index table 416 for all the search keys in look-ahead queue 406 and fill these addresses in the corresponding entry of look-ahead queue 406. Accordingly, this allows index manager 402 to avoid re-traversing the B-tree of index table 416 for the same search keys in the future. If there is no match found in index table 416, index manager 402 will fill in zero as the corresponding index leaf addresses.

Index manager 402 may then accumulate the RIDs that match the search keys into prefetch list 408. Index manager 402 may selectively wait for prefetch list 408 to become available. For example, index manager 402 may read the rid_empty flag to determine the status of prefetch list 408. If rid_empty flag is “no,” then index manager 402 may wait until the flag becomes yes (i.e., indicating that prefetcher 404 has scheduled all the prefetches for the previous scans of index table 416). If rid_empty flag is “yes,” for each index search key, index manager 402 may fill in all the matching RIDs that it found in the scan of index table 416. Index manager 402 may then set the rid_empty flag to “no” to notify prefetcher 404 of a pending set of prefetches that need to be scheduled.

If prefetch list 408 is not big enough to hold all the RIDs that index manager 402 needs to enter, then index manager 402 may fill in as many RIDs as possible into prefetch list 408 and may then set a continuation flag, such as a “rid_fill_cont” flag to yes. Index manager 402 may also set a flag, such as “next_prefetch_entry,” to indicate the next entry of look-ahead queue 406 to start with when refilling prefetch list 408 the next time. The next time that index manager 402 checks the status of prefetch list 402, it will then find rid_fill_cont flag is set to “on.” Then, as noted, this indicates that prefetch list 408 should continue to be filled for the same, current entry being processed by index manager 402.

If prefetch list 408 is big enough to hold the RIDs that index manager 402 needs to enter, then index manager 402 may set the rid_fill_cont flag to “no,” and may also set next_prefetch_entry flag to zero. Index manager 402 may also return the requested RID for the current search key to coordinator agent 400 for eventual passing to application 110.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of prefetching records of a table before they are requested by a transaction, wherein said transaction is based on a set of keys, said method comprising:
queuing a plurality of the set of keys of the transaction;
scanning an index of the table based on the queued set of keys;
accumulating locations of records in the table based on the scan of the index;
determining respective pages that include the accumulated records; and
fetching the pages that include the accumulated records before they are requested , by the transaction.

2. The method of claim 1, wherein queuing the plurality of the set of keys of the transaction comprises:
queuing the plurality of the set of keys of the transaction, when a pipelined index access plan has been specified for the transaction.

3. The method of claim 1, wherein queuing the plurality of the set of keys of the transaction comprises:
determining when the queue of the plurality of keys is empty; and
refilling the queue of the plurality of keys when the queue is empty.

4. The method of claim 1, wherein scanning the index of the table based on the queued set of keys comprises:
scanning the index based on all of the queued set of keys.

5. The method of claim 4, wherein the index comprises a B-tree structure and wherein scanning the index of the table based on the queued set of keys comprises retrieving index leaf pages in the B-tree structure for all the queued set of keys.

6. The method of claim 1, wherein accumulating locations of records in the table based on the scan of the index comprises accumulating all the record identifiers in the table that satisfy the queued set of keys.

7. The method of claim 6, wherein determining respective pages that include the accumulated records comprises determining the respective pages that include the records based on a portion of the record identifier.

8. The method of claim 1, wherein determining respective pages that include the accumulated records comprises determining a list of unique pages that include the accumulated records.

9. The method of claim 8, wherein fetching the pages that include the accumulated records comprises fetching the unique pages from at least one storage device into a memory unless they are already cached in the memory.

10. A system that processes transactions, wherein the system is configured to prefetch records of a table before they are requested by the transactions, said system comprising:
at least one look-ahead queue having entries for search keys specified in a transaction;
a buffer pool that comprises at least a portion of a table and an index of the table, wherein the index comprises a set of entries each having an index key that indicates a value for a field of the table and a record identifier that indicates a location of a record that has the value in the field;
an index manager that is configured to scan the index based on the search keys in the entries in the look-ahead queue and write the record identifiers of the records in the table that satisfy the search keys into a prefetch list; and
a prefetcher that is configured to read the prefetch list, determine a set of pages that contain the records that satisfy the search keys, and fetch the set of pages before they are requested by the transaction.

11. The system of claim 10, wherein the prefetcher is configured to empty the prefetch list asynchronously from when the index manager writes to the prefetch list.

12. A computer readable medium having program code that configures a processor to prefetch records of a table before they are requested by a transaction, wherein said transaction is based on a set of keys, said medium comprising:
program code for queuing a plurality of the set of keys of the transaction;
program code for scanning an index of the table based on the queued set of keys;
program code for accumulating locations of records in the table based on the scan of the index;
program code for determining respective pages that include the accumulated records; and
program code for fetching the pages that include the accumulated records before they are requested by the transaction.

13. The computer readable medium of claim 12, wherein the program code for queuing the plurality of the set of keys of the transaction comprises:
program code for queuing the plurality of the set of keys of the transaction, when a pipelined index access plan has been specified for the transaction.

14. The computer readable medium of claim 12, wherein the program code for queuing the plurality of the set of keys of the transaction comprises:
program code for determining when the queue of the plurality of keys is empty; and
program code for refilling the queue of the plurality of keys when the queue is empty.

15. The computer readable medium of claim 12, wherein the program code for scanning the index of the table based on the queued set of keys comprises:
program code for scanning the index based on all of the queued set of keys.

16. The computer readable medium of claim 12, wherein the index comprises a B-tree structure and wherein the program code for scanning the index of the table based on the queued set of keys comprises program code for retrieving index leaf pages in the B-tree structure for all the queued set of keys.

17. The computer readable medium of claim 12, wherein the program code for accumulating locations of records in the table based on the scan of the index comprises program code for accumulating all the record identifiers in the table that satisfy the queued set of keys.

18. The computer readable medium of claim 12, wherein the program code for determining respective pages that include the accumulated records comprises program code for determining the respective pages that include the records based on a portion of the record identifier.

19. The computer readable medium of claim 12, wherein the program code for determining respective pages that include the accumulated records comprises program code for determining a list of unique pages that include the accumulated records.

20. The computer readable medium of claim 12, wherein the program code for fetching the pages that include the accumulated records comprises program code for fetching the unique pages from at least one storage device into a memory unless they are already cached in the memory.
